(19) United States
(12) Patent Application Publication
(10) Pub. No.: US 2026/0054214 A1
(43) Pub. Date: Feb. 26, 2026

(54) Fluid Separation System

(71) Applicant: Vacuum Engineering Services Ltd, Manchester (GB)

(72) Inventor: John Watson, Manchester (GB)

(21) Appl. No.: 18/998,946

(22) PCT Filed: Jul. 26, 2023
(86) PCT No.: PCT/GB2023/051967

§ 371 Date: Jan. 27, 2025

(30) Foreign Application Priority Data
Jul. 28, 2022 (GB) 2211006.8

(51) Int. Cl. B01D 53/22; B01D 65/10

(52) U.S. Cl. CPC B01D 53/22; B01D 65/104; B01D 2053/224; B01D 2311/14; B01D 2311/16; B01D 2311/2698

(57) ABSTRACT

There is disclosed a fluid separation system (16) for recovering a target fluid from a fluid mixture. The fluid recovery system (16) comprises an inlet (18) that is configured to receive the fluid mixture; a first compressor (24) for compressing the fluid mixture; a return line (26) that comprises a return line inlet (28) that is disposed downstream of the first compressor, such that, in use, 2024/023507 the fluid mixture is divided into a first portion (34) and a second portion (36); and a separation device (30) that is disposed downstream of the return line inlet (28). The return line (26) is configured to return the second portion (36) to upstream of the first compressor (22). In use, the first portion (34) is provided to the separation device (30) at a predetermined flow rate.

### FIELD OF INVENTION

The present invention relates to a method of separating a target fluid from a fluid mixture. The present invention also relates to a fluid separation system.

### BACKGROUND

Components which, in use, will contain liquid or gas and cannot be permitted to leak may be subject to leak testing in order to check the component for potential leak sites.

Components from a large variety of applications may be subject to leak testing, for example refrigeration and air conditioning equipment and automotive parts, such as gasoline tanks.

Helium leak testing is one method of detecting small leaks. Conventional helium leak testing involves placing a component to be leak tested in a chamber, sealing the chamber and subsequently evacuating an internal volume of the chamber such that it is at a reduced pressure. The internal volume of the component is then charged with a tracer gas, such as helium. The tracer gas mixes with any residual fluid that remains in the internal volume of the component following the evacuation. The tracer gas and the residual fluid form a fluid mixture. A mass spectrometer, in fluid communication with the chamber volume, is used to determine if the tracer gas is leaking out of the component and into the chamber volume.

The fluid mixture that is within the internal volume of the component is then pumped out such that it can be used again for a subsequent leak test. Since the tracer gas mixes with the residual fluid in the internal volume of the component, the concentration of the tracer gas that exits the internal volume of the component is less than the concentration of the tracer gas with which the internal volume of the component was charged. Current methods to account for this reduction in concentration include periodically adding pure tracer gas to the system to increase the tracer gas concentration.

It is an object of the present invention obviate, or at least mitigate, one or more disadvantages present in the prior art.

### SUMMARY

In a first aspect of the invention there is provided a method of separating a target fluid from a fluid mixture. The method comprises receiving the fluid mixture from an apparatus; compressing the fluid mixture using a first compressor; dividing the fluid mixture into a first portion and a second portion; returning the second portion to upstream of the first compressor; providing the first portion to a separation device at a predetermined flow rate; and separating the target fluid from the first portion of the fluid mixture with the separation device.

Although the first portion is provided to the separation device at a predetermined flow rate, it is to be appreciated that there can be a tolerance to the flow rate. The method may include maintaining the flow rate of the first portion at the predetermined flow rate. The predetermined flow rate of the first portion may be a mass flow rate. The predetermined flow rate of the first portion may be a volumetric flow rate. The flow rate of the first portion may be a volumetric flow rate. The method may be a method of recovering a target fluid from a fluid mixture.

The fluid mixture received from the apparatus may be stored in a vessel prior to being compressed by the first compressor. The method may comprise receiving the fluid mixture from a plurality of apparatus. The plurality of apparatus may be leak testing, preferably helium leak testing, apparatus.

The target fluid may exit the separation device via a first line. The first line may be referred to as a target fluid line. The remainder of the first portion of the fluid mixture (the portion that does not contain any, or only trace amounts, of the target fluid) may exit the separation device via a second line. The second line may be referred to as a vent line.

Since the second portion is returned to upstream of the first compressor, and the first portion is provided to the separation device at a predetermined flow rate, the efficiency by which the target fluid is separated from the first portion is improved relative to if the entire fluid mixture were provided to the separation device. This is because the flow rate of the first portion can be optimised such that it is not too high or too low, thereby improving the efficiency of separation of the target fluid from the first portion.

In addition, since the fluid mixture is divided into a first portion that comprises a portion of the fluid mixture up to a predetermined threshold value, the flow of fluid into and through the separation device is more consistent as compared to if the fluid mixture were not divided before passing into and through the separation device. More consistent flow of fluid into and through the separation device advantageously further improves the efficiency by which the separation device separates the target fluid from the first portion of the fluid mixture.

Since the second portion of the fluid mixture is returned to upstream of the first compressor, the target fluid present in the second portion is retained. This allows the target fluid present in the second portion of the fluid mixture to be separated subsequent to being returned upstream of the first compressor. This further improves the efficiency of the separation of the target fluid from the fluid mixture.

The method may further comprise regulating, the pressure of the first portion of the fluid mixture that is disposed in the fluid separation device. The pressure may be regulated with a pressure control device that is disposed downstream of the separation device,

The pressure control device may be disposed on the vent line. The pressure control device may be a valve. The pressure control device may be a backpressure regulator valve.

The pressure control device may be in parallel with respect to the separation device.

Regulating the pressure of the first portion of the fluid mixture that is disposed in the fluid separation device may comprise limiting the pressure of fluid in the fluid separation device to a predetermined threshold value.

Where the pressure of the first portion of the fluid mixture that is disposed in the separation device is regulated with a pressure control device that is disposed downstream of the separation device, the efficiency by which the separation device is able to separate the target fluid from the first portion of the fluid mixture is advantageously improved. That is, as compared to where the pressure of the fluid in the separation device is not regulated. The efficiency by which the separation device is able to separate the target fluid from the first portion of the fluid mixture is improved because the operating conditions of the separation device can be optimised for separation of the target fluid.

Regulating the pressure in the fluid separation device may comprise maintaining the pressure of the first portion of the fluid mixture that is disposed in the fluid separation device within a predetermined pressure range.

Where regulating the pressure of the first portion of the fluid mixture that is disposed in the fluid separation device comprises maintaining the pressure in the fluid separation device within a predetermined pressure range, separation of the target fluid from the fluid mixture can be optimised such that the efficiency by which the target fluid can be separated from the first portion of the fluid mixture is advantageously improved. That is, as compared to where the pressure of first portion of the fluid mixture that is disposed in the fluid separation device is not regulated. Improving the efficiency by which the separation device separates the target fluid from the fluid mixture advantageously improves the yield of the target fluid from the fluid mixture.

Regulating the pressure in the fluid separation device may comprise maintaining the pressure of the first portion of the fluid mixture that is disposed in the fluid separation device at a predetermined pressure value.

Although the first portion of the fluid mixture that is disposed in the fluid separation device is maintained at a predetermined pressure, it is to be appreciated that there can be a tolerance to the predetermined pressure value.

Where regulating the pressure in the fluid separation device comprises maintaining the pressure of the first portion of the fluid mixture that is disposed in the fluid separation device at a predetermined pressure value, the pressure of the fluid in the separation device is advantageously stable. This is desirable because it allows quick and simple determination of the output characteristics (such as the concentration of target fluid). This is because, where the operating parameters are stable, the operating parameters can be compared to historical data for which the output characteristics are known. This allows the output characteristics to be inferred while the method is being carried out. In addition, where the operating parameters are stable, the output characteristics are also stable. This allows the output characteristics to be determined more accurately as compared to where the operating parameters are not stable because there is no need to determine an average of the output characteristics, as would be the cast where the output characteristics are not stable.

Returning the second portion to upstream of the compressor may comprise returning the second portion to upstream of the compressor via a return line. An inlet of the return line may be disposed downstream of the compressor.

The flow rate of the first portion may be controlled using a flow control device that is disposed on the return line.

The return line may comprise the flow control device. The flow control device may be disposed downstream of an inlet of the return line.

Where the flow control device is disposed downstream of an inlet of the return line, the flow control device is subject to less heating than if, for example, the flow control device were disposed at the inlet of the return line. This is because the flow control device only receives the fluid that passes through the return line. In addition, when positioned downstream of an inlet to the return line, the flow control is further away from the first compressor, which increases the temperature of the fluid mixture, than if it were disposed at the inlet to the return line. Subjecting the flow control device to less heating is desirable because heating can affect operation of the flow control device, which can affect its accuracy.

The method of may further comprise: providing the separated target fluid to a first vessel; compressing the target fluid with a second compressor; and providing the compressed target fluid to a second vessel.

The compressed target fluid may be provided to the second vessel via a non-return valve.

The first vessel may be a flexible vessel. The first vessel may be made of rubber. The first vessel may be referred to as an intermediate storage volume. The first vessel may be referred to as an intermediate gas storage volume. The first vessel may be referred to as a flexible intermediate storage volume. The first vessel may be referred to as a flexible intermediate gas storage volume.

The second vessel may be rigid. The second vessel may be made of metal. The second vessel may be a rigid vessel. The second vessel may be referred to as a target fluid storage volume. The second vessel may be referred to as a rigid target fluid storage volume.

Where the target fluid is compressed and then provided to a second vessel via a non-return valve, the steps of the method that precede compressing the target fluid can be performed independently of the steps of the method that follow compressing the target fluid. This advantageously allows the method to be carried out in an efficient manner. For example, the second compressor may be activated when the amount of target fluid in the first vessel reaches a first threshold value. The first compressor may be operating while the second compressor is not operating. Once the amount of target fluid in the first vessel reaches the threshold value, the second compressor can be activated to draw target fluid from the first vessel to be passed to the second vessel. Once the amount of target fluid in the first vessel falls below a second threshold value, the second compressor can be deactivated. Therefore, the second compressor need not remain active throughout the method.

Subsequent to being compressed by the second compressor, the method may comprise filtering the target fluid with a filter. Filtering the target fluid may be carried out to remove, for example, dirt and/or oil and/or moisture from the fluid mixture.

The method may further comprise, prior to separating the target fluid from the first portion of the fluid mixture, filtering the fluid mixture.

The fluid mixture may be filtered subsequent to being compressed by the first compressor.

Filtering the fluid mixture may be carried out to remove, for example, dirt and/or oil and/or moisture from the fluid mixture.

Where the fluid mixture is filtered prior to separating the target fluid from the first portion of the fluid mixture, the separation of the target fluid from the first portion of the fluid mixture is advantageously more efficient that where the fluid mixture is not filtered prior to the target fluid being separated from the fluid mixture. This is because filtering the fluid removes contaminants, such as dust particles, which can impair the ability of the separation device to separate the target fluid from the fluid mixture.

Filtering the fluid mixture may remove moisture from the fluid mixture.

Where filtering the fluid mixture removes moisture from the fluid mixture, the efficiency of the separation of the target fluid from the fluid mixture is advantageously improved.

The separation device may be a gas separation module.

The separation device may be a membrane filter.

The apparatus may be a leak testing apparatus.

The target fluid may be helium.

In a second aspect of the invention there is provided a fluid separation system for recovering a target fluid from a fluid mixture. The fluid recovery system comprises an inlet that is configured to receive the fluid mixture; a first compressor for compressing the fluid mixture; a return line that comprises a return line inlet that is disposed downstream of the first compressor, such that, in use, the fluid mixture is divided into a first portion and a second portion; and a separation device that is disposed downstream of the return line inlet. The return line is configured to return the second portion to upstream of the first compressor. In use, the first portion is provided to the separation device at a predetermined flow rate.

The features and advantages discussed in relation to the first aspect of the invention apply to this aspect mutatis mutandis.

The fluid separation system may be a fluid recovery apparatus. The separation device may not be disposed on the return line. The separation device may be configured, in use, to separate the target fluid from the first portion of the fluid mixture.

The separation device may be a membrane filter. The separation device may be a gas separation module. The target fluid may be helium. The predetermined value may be a predetermined volumetric flow rate. The predetermined value may be a predetermined mass flow rate.

The return line may comprise a flow control device.

The flow control device may be disposed downstream of an inlet of the return line.

The fluid recovery system may further comprise a pressure control device that is disposed downstream of the separation device.

The pressure control device may be configured, in use, to regulate the pressure of the first portion of the fluid mixture that is disposed in the separation device.

In use, the pressure control device may be configured to maintain the pressure of the first portion of the fluid mixture that is disposed in the separation device at a predetermined pressure value.

In use, the pressure control device may be configured to maintain the pressure of the first portion of the fluid mixture that is disposed in the separation device within a predetermined pressure range.

The fluid recovery system may further comprise a filter that is disposed upstream of the separation device.

The filter may be configured to remove moisture from the fluid mixture in use.

In a third aspect of the invention there is provided an apparatus. The apparatus comprises the fluid recovery system of the second aspect of the invention; and a leak testing apparatus, an outlet of the leak testing apparatus being in fluid communication with the inlet of the fluid recovery system.

The leak testing apparatus may be a helium leak testing apparatus.

The apparatus may further comprise one or more further leak testing apparatus, an outlet of each of the one or more further leak testing apparatus being in fluid communication with the inlet of the fluid recovery system.

Each of the one or more further leak testing apparatus may be helium leak testing apparatus.

### BRIEF DESCRIPTION OF THE DRAWINGS

Embodiments of the present invention will now be described with reference to the accompanying drawings, in which:

FIG. 1 shows a schematic view of a leak testing apparatus;

FIG. 2 shows a schematic view of a fluid recovery apparatus in accordance with an embodiment of the present invention, the fluid recovery apparatus being in fluid communication with the leak testing apparatus of FIG. 1; and

FIG. 3 shows a cross-sectional view of a separation device of the fluid recovery apparatus of FIG. 2.

### DETAILED DESCRIPTION

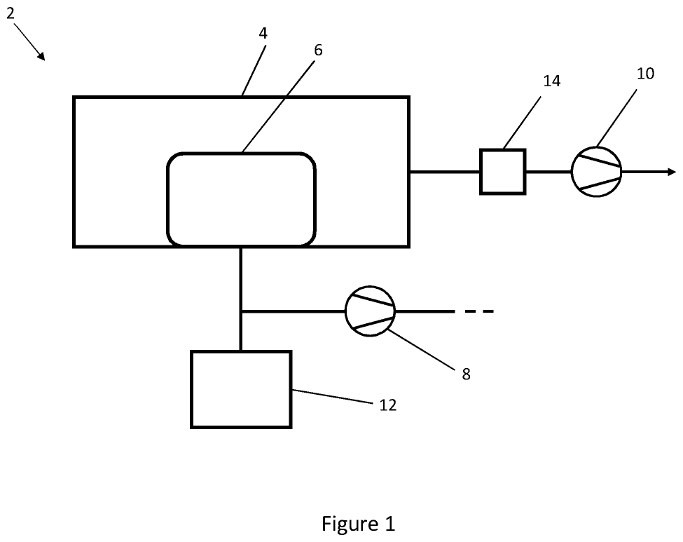

FIG. 1 shows a leak testing apparatus 2. The leak testing apparatus 2 comprises a chamber 4. A component 6 is received within the chamber 4. To leak test the component 6, a first pump 8 is used to evacuate an internal volume of the component 4 and a second pump 10 is used to evacuate the chamber. However, fluid may remain in the chamber 4 and/or internal volume of the component 6 such that a true vacuum is not achieved. Throughout this document, the term vacuum may be understood to refer to a volume of reduced pressure (i.e., reduced to below atmospheric pressure), for example less than 100 mbar. The pressure of the chamber 4 and the internal volume of the component 6 following evacuation may be approximately 10 mbar. Throughout this document, where a pressure value is specified, the pressure value is provided as an absolute pressure value.

The internal volume of the component 6 is then charged with a tracer fluid from a tracer fluid source 12. The tracer fluid may be helium. Following this, the pressure of the fluid within the internal volume of the component 6 may be equal to or greater than 100 mbar. The fluid within the chamber 4 is then passed through a fluid detection device 14. If the tracer fluid is detected by the fluid detection device 14 in a concentration that is below a threshold value, the component 4 is deemed to have passed the leak test. The amount of tracer fluid detected by the fluid detection device 14 may be zero. If the tracer fluid is detected by the fluid detection device 14 in a concentration that is above the threshold value, the component 4 is deemed to have failed the leak test.

Once the leak test has been performed, the fluid within the internal volume of the component 6, which is mainly the tracer fluid, is then evacuated by the first pump 8. Fluid is allowed into the chamber 4, e.g. by venting the chamber 4 to the atmosphere.

The fluid from the internal chamber of the component 6 (which as mentioned is mainly tracer fluid) is passed to a vessel (not shown). It is desirable to preserve as much tracer fluid as possible following evacuation of the internal volume of the component. However, the internal volume of the component 6 is not in a complete vacuum state following evacuation and prior to being charged with tracer fluid. Therefore, the tracer fluid mixes with residual fluid that remains following evacuation of the internal volume of the component 6. Because of this, the concentration of tracer fluid that is pumped out by the first pump 8 is less than the concentration of tracer fluid that the internal volume of the component was charged with (some contamination from other fluids has occurred). Known methods to account for this reducing of tracer fluid concentration include adding pure tracer to the vessel, thereby increasing the tracer fluid concentration. This method is not ideal because tracer fluid consumption is increased relative to if no additional tracer fluid were added.

In some embodiments, the leak testing apparatus 2 can be operated in reverse, such that the chamber 4 is charged with the tracer fluid and the fluid within the internal volume of the component 6 is monitored for the presence of the tracer fluid. Where the chamber 4 is charged with tracer fluid and the internal volume of the component 6 is monitored for the presence of the tracer fluid, one the leak test has been performed, the fluid within the chamber 4 is evacuated by a pump, and fluid is allowed into the internal volume of the component 6.

The most rigorous tracer fluid to use for a leak test is helium. This is because helium has the smallest atomic size of any element and so is able to pass through smaller cracks than any other substance. In addition, helium is inert and so poses a reduced risk of harm as compared to other fluids. Helium is expensive, and thus using additional helium is not desirable.

The present invention seeks to obviate, or at least mitigate, the above disadvantage.

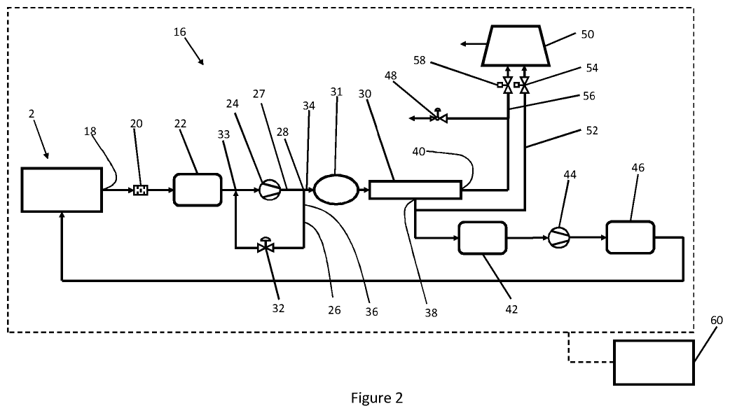

FIG. 2 shows a schematic view of a fluid separation system 16 in accordance with an embodiment of the present invention. The fluid separation system 16 may also be referred to as a fluid recovery apparatus. The fluid separation system 16 is in fluid communication with the leak testing apparatus 2. In particular, an inlet 18 of the fluid recovery system is in fluid communication with the leak testing apparatus 2. Although only a single leak testing apparatus 2 is shown, in some non-depicted embodiments, the fluid separation system 16, in particular the inlet 18 of the fluid separation system 16, may be in fluid communication with a plurality of leak testing apparatus. In the depicted embodiment, the inlet 18 receives the fluid that is pumped from the internal volume of the component that is being leak tested. In embodiments where the chamber of the leak testing apparatus is charged with the tracer fluid, the inlet 18 receives fluid that is pumped from the chamber following a leak test. Since the fluid that is received by the inlet 18 is a mixture of the tracer fluid and of the residual fluid that remained in the internal volume of the component following evacuation, the fluid that the inlet 18 receives is a fluid mixture. The inlet 18 is configured to receive the fluid mixture. The tracer fluid used by the leak testing apparatus may be referred to as a target fluid.

A filter 20 is disposed downstream of the inlet 18. The filter 20 is provided to remove contaminants, such as moisture and/or dirt and/or oil, from the fluid mixture. Although only a single filter 20 is shown in FIG. 2, in some embodiments one or more further filters may be provided. The number of filters provided may be dependent upon, for example, the required purity of the fluid mixture.

A first vessel 22 is disposed downstream of the filter 20. The first vessel 22 may be referred to as an inlet vessel 22. The first vessel 22 is a variable volume, constant pressure, vessel. Therefore, as the first vessel fills with the fluid mixture, the volume of the first vessel 22 increases, while the pressure of the fluid that is received in it remains constant. As the fluid mixture exits the first vessel 22, the volume of the first vessel decreases, while the pressure of the fluid that is received in it remains constant. The first vessel 22 may be a flexible vessel. The first vessel 22 may be a flexible bag. In some embodiments, the first vessel 22 may be a rigid vessel. In some, non-depicted embodiments, a vent may be provided upstream of the first vessel 22 and downstream of the filter 20. The vent may be used to vent the fluid mixture to the atmosphere. The fluid mixture may be vented to the atmosphere, for example, during an emergency, to perform maintenance of the fluid separation system 16, or if the fluid separation system 16 breaks down.

A first compressor 24 is disposed downstream of the first vessel 22. The first compressor 24 is a screw compressor. In some embodiments, the first compressor 24 may be pump. The first compressor 24 may be a centrifugal pump. In other embodiments, any other suitable type of pump or compressor may be used. In use, the first compressor 24 compresses the fluid mixture. In use, the first compressor 24 is activated when the amount of the fluid mixture present in the first vessel 22 reaches a first threshold value. The first threshold value may correspond to, for example, the first vessel 22 being 95% full. In other words, the volume of the first vessel 22 may be 95% of the maximum volume of the first vessel 22 when the first compressor 24 is activated. Other first threshold values may be used, e.g. 90%. In some embodiments, the first threshold value may be at least 90%. In some embodiments, the first threshold value may be at least 95%. Once the amount of fluid mixture present in the first vessel 22 falls to a second threshold value, the first compressor 24 is deactivated. The second threshold value may correspond to, for example, the first vessel 22 being 10% full. Other second threshold values may be used, e.g. 15%. In some embodiments, the second threshold value may be less than or equal to 15%. In some embodiments, the second threshold value may be less than or equal to 5%.

The fluid separation system 16 comprises a return line 26. The return line branches off from a main line 27. An inlet 28 of the return line 26 is disposed downstream of the first compressor 24. In use, the fluid mixture is divided into a first portion 34, which does not enter the return line 26, and a second portion 36, which does enter the return line 26. An outlet 33 of the return line 26 is disposed upstream of the first compressor 24. The return line 26 comprises a flow control device 32. The flow control device 32 may be a flow control valve. The flow control device 32 may be a mass flow control valve. In some embodiments, the flow control device 32 may define the inlet 28 of the return line 26. That is to say, the flow control device 32 may be disposed at a junction defined by the return line 26 and the main line 27. However, it is preferable to dispose the flow control valve on the return line 26, downstream of the inlet 28 (i.e., downstream of the junction defined by the return line 26 and the main line 27). This is because the temperature of the fluid mixture is increased when being compressed by the first compressor 24. Where the flow control device 32 is disposed at the junction, both the first portion 34 and the second portion 36 of the fluid mixture pass through it. This heats the flow control device 32 by more than where the flow control device 32 is disposed downstream of the junction. In addition, the temperature of the fluid mixture at the junction is greater than the temperature of the second portion 34 on the return line because the junction is closer to the first compressor 24. This also heats the flow control device 32 by more than where the flow control device 32 is disposed downstream of the junction. Therefore, where the flow control device 32 is disposed downstream of the junction, it is heated by less than where the flow control device 32 is disposed at the junction. Subjecting the flow control device 32 to less heat improves the operation of the flow control device. For example, subjecting the flow control device to less heat improves the accuracy of the flow control by the flow control device 32.

A separation device 30 is disposed downstream of the inlet 28 of the return line 26. The first portion 34 of the fluid mixture continues on to the separation device 30, as will be discussed in more detail below. The first portion 34 does not enter the return line 26. The fluid separation system 16 comprises a flow meter 31. The flow meter 31 is disposed downstream of the inlet 28 of the return line. The flow meter 31 is disposed upstream of the separation device 30. The flow meter 31 measures the flow rate of the first portion 34 of the fluid mixture.

The return line 26 is configured to return the second portion 36 of the fluid mixture to upstream of the first compressor 24. The proportion (by mass, where the flow control device 32 is a mass flow control valve) of the fluid mixture that each of the first portion 34 and the second portion 36 comprise is determined by the flow control device 32. The flow control device 32 limits the flow rate of the first portion 34. The flow control device 32 may be a mass flow control valve. This allows the first portion 34 to be provided to the separation device 30 at a predetermined flow rate. The flow rate of the first portion 32 may be maintained at the predetermined flow rate. Although the first portion 34 is provided to the separation device at a predetermined flow rate, it is to be appreciated that there can be a tolerance to the flow rate. The tolerance may for example be −40%, +20% of the predetermined flow rate. The second portion 36 of the fluid mixture comprises the remainder of the fluid mixture (i.e., excluding the first portion 34). To provide the first portion 34 to the separation device 30 at the predetermined flow rate, the flow rate of the first portion is measured using the flow meter 31. The flow control device 32 of the return line 26 is then set such that the flow rate of the second portion 36 is that which is in excess of the predetermined flow rate of the first portion 34. For example, if the predetermined flow rate to be provided to the separation device 30 is 5 m³/hour and the total flow rate of the fluid mixture downstream of the first compressor 24 and upstream of the inlet 28 of the return line 26 is 15 m³/hour, the flow control device is set to allow 10 m³/hour through it, thereby allowing 5 m³/hour to continue to the separation device 30.

In use, the flow rate of the first portion 34 of the fluid mixture is 5 m³/hour. However, it will be appreciated that other values are also suitable. The flow rate of the first portion 34 is determined, at least in part, by the desired tracer gas yield, and the desired rate at which the fluid mixture is processed by the fluid separation system 16. A higher flow rate reduces tracer gas yield, but more of the fluid mixture can be processed within a given time period. A lower flow rate increases tracer gas yield, but less of the fluid mixture can be processed within a given time period. Throughout this document, tracer gas yield refers to the amount of tracer gas that is obtained from the fluid mixture.

In some, non-depicted, embodiments, one or more filters may be disposed downstream of the compressor 24 and upstream of the inlet 28 of the return line 26. The purpose of the further filters is to remove contaminants, such as oil and/or moisture and/or dust, from the fluid mixture. Whether or not the further filters are provided may be dependent on, for example, the type of component that is being tested by the leak test apparatus 2.

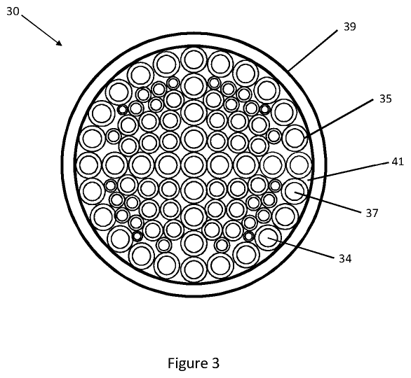

As discussed above, the fluid separation system 16 comprises a separation device 30. The separation device 30 is disposed downstream of the inlet 28 of the return line 26 The separation device 30 is disposed downstream of the flow meter 31. The separation device 30 is a gas separation module. The separation device 30 may be a membrane filter. In some embodiments, the separation device 30 may be a Sepuran® device, which is manufactured by Evonik. The separation device 30 comprises a first outlet 38. The separation device comprises a second outlet 40. FIG. 3 shows a cross-sectional view of the separation device 30. The separation device 30 comprises a plurality of hollow fibres 35. Although FIG. 3 depicts the hollow fibres 35 in a range of diameters, this need not be the case. In some embodiments, the diameter of each of the hollow fibres may be generally equal to one another. Since the fibres 35 are hollow, each hollow fibre 35 defines a central passage 37. The hollow fibres 35 are disposed in a hollow body 39. The hollow body 39 defines a volume 41 in which the hollow fibres 35 are disposed. In use, the first portion 34 of the fluid mixture is passed into the central passages 37 of the hollow fibres 35. The target fluid passes radially through the hollow fibres 35, and the remainder of the first portion 34 of the fluid mixture passes from the central passages 37 to the second outlet (not visible in FIG. 3). Therefore, in use, the separation device 30 separates the target fluid from the first portion 34 of the fluid mixture. The target fluid exits the separation device 30 via the first outlet (not visible in FIG. 3), and the remainder of the first portion 34 of the fluid mixture exits the separation device 30 via the second outlet (not visible in FIG. 3). Some of the target fluid may exit the separation device 30 via the second outlet. Some of the first portion 34 of the fluid mixture that is not the target fluid may exit the separation device 30 via the first outlet.

Throughout this document, the efficiency by which the separation device is able to separate the target fluid from the first portion 34 of the fluid mixture refers to the yield of target fluid that is obtained from the first portion 34 of the fluid mixture as a proportion of the total amount of target fluid (or tracer fluid) that was provided to the internal volume of the component during the leak test operation. The efficiency by which the separation device 30 is able to separate the target fluid from the first portion 34 of the fluid mixture is a function of the flow rate of the first portion 34 through the separation device 30, and the pressure of the fluid in the separation device 30, in particular the pressure of the first portion of the fluid mixture that is disposed in the separation device 30. A higher flow rate of the first portion 34 results in a lower efficiency of separation of the target fluid from the first portion 34 by the separation device 30 as compared to a lower flow rate. For the pressure of the first portion 34 of the fluid mixture, an optimum value is sought. If the pressure of the first portion is too high or too low, the target fluid yield will be less than if the pressure of the first portion is at an optimum value. The efficiency by which the separation device 30 is able to separate the target fluid from the first portion 34 is also a function of the geometry of the separation device 30. For example, a longer and/or wider separation device is more efficient at separating the target fluid from the first portion 34 of the fluid mixture than a shorter and/or narrower separation device.

Referring back to FIG. 2, a second vessel 42 is disposed downstream of the first outlet 38 of the separation device 30. The second vessel 42 is of similar construction to the first vessel 22. Therefore, the discussion above in relation to the first vessel 22 applies to the second vessel 42 mutatis mutandis. In some embodiments, the second vessel 42 may be a rigid vessel. The second vessel 42 may be referred to as an intermediate storage volume. The second vessel 42 may be referred to as an intermediate gas storage volume. A second compressor 44 is disposed downstream of the second vessel 42. In use, the second compressor 44 is activated when the amount of target fluid present in the second vessel 42 reaches a first threshold value. The first threshold value may correspond to, for example, the second vessel 42 being 95% full. In other words, the volume of the second vessel 42 may be 95% of the maximum volume of the second vessel 42 when the second compressor 44 is activated. In some embodiments, the first threshold vale may be at least 90%. In some embodiments, the first threshold vale may be at least 95%. Once the amount of target fluid present in the second vessel 42 falls to a second threshold value the second compressor 44 is deactivated. The second threshold value may correspond to, for example, the second vessel 42 being 10% full. Other values for the second threshold value may be used, e.g. 15%. In some embodiments, the second threshold value may be less than or equal to 15%. In some embodiments, the second threshold value may be less than or equal to 5%.

A third vessel 46 is disposed downstream of the second compressor 44. The third vessel 46 is a rigid vessel. However, in some embodiments, the third vessel 46 may be a flexible vessel, such as a flexible bag. When the second compressor 44 is active, the target fluid is passed to the third vessel 46 by virtue of the pumping action of the second compressor 44. The third vessel 46 is disposed upstream of the leak testing apparatus 2. Therefore, from the third vessel 46, the target fluid can be passed to the leak testing apparatus 2 for use in a leak test operation. A non-return valve is disposed between the third vessel 46 and the leak testing apparatus 2.

A pressure control device 48 is disposed downstream of the separation device 30. The pressure control device 48 is disposed downstream of the second outlet 40 of the separation device 30. The pressure control device 48 is a pressure control valve 48. The pressure control device 48 is a back pressure regulation valve. The pressure control device 48 is in direct fluid communication with the central passages of the hollow fibres (not visible in FIG. 2). Therefore, pressure control device 48 is configured to regulate the pressure of the first portion 34 of the fluid mixture that is disposed in the separation device 30. In particular, the pressure control device 48 is configured to maintain the pressure of the first portion 34 of the fluid mixture that is disposed in the separation device 30 at a predetermined pressure value. The predetermined pressure value may be 10 bar. However, it is to be understood that there can be a tolerance for the predetermined pressure value. The tolerance may for example be ±10% of the predetermined pressure value. In some embodiments, the pressure control device may be configured to maintain the pressure of the first portion 34 of the fluid mixture that is disposed in the separation device 30 within a predetermined pressure range. The predetermined pressure range may include the predetermined pressure value. The predetermined pressure value may be 10 bar. The pressure of the first portion 34 of the fluid mixture that is disposed in the separation device 30 also influences the pressure of the separated target fluid at the first outlet 38 of the separation device. Therefore, the set point of the pressure control device 48 influences the pressure of the separated target fluid at the first outlet 38 of the separation device 30. The pressure of the separated target fluid at the first outlet 38 of the separation device 30 is proportional to the set point of the pressure control device 48.

As discussed above, the efficiency by which the separation device 30 is able to separate the target fluid from the first portion of the fluid mixture is a function of the pressure of the first portion 34 of the fluid mixture that is disposed in the separation device 30. As is also discussed above, an optimum value is sought. The optimum value will depend on, for example, the target fluid in question, and the flow rate of the first portion 34 of the fluid mixture. Downstream of the pressure control device 48, the remainder of the first portion 34 of the fluid mixture is vented to the atmosphere. In use, the pressure control device 48 is configured to maintain the pressure of the first portion 34 of the fluid mixture that is disposed in the separation device at a predetermined value.

It is also desirable to maintain the operating parameters, such as the pressure and flow rate of the first portion 34, at stable values (e.g., within 5% of the predetermined value). This is desirable because it allows quick and simple determination of the output characteristics (such as the concentration of target fluid at the first outlet 38). This is because, where the pressure and flow rate of the first portion 34 are stable, the operating parameters can be compared to historical parameters for which the output characteristics are known from measurements, thereby allowing the output characteristics to be inferred during operation of the fluid separation system 16. In addition, where the operating parameters are stable, the output characteristics are also stable. This allows the output characteristics to be determined more accurately as compared to where the operating parameters are not stable. The output characteristics are measured periodically (e.g., once every ten seconds). Where the output characteristics are not stable, an average of the measurements taken is calculated. However, since the output characteristics are measured periodically, the average value calculated is not a true reflection of the output characteristics because it does not account for fluctuations in the values of the output characteristics between measurements. By maintaining the operating parameters at stable values, the values for the output characteristics are also stable. Where the values of the output characteristics are stable, there is no need to determine an average of the measurements taken. Therefore, maintaining the operating parameters at stable values allows the output characteristics to be determined accurately.

The fluid separation system 16 further comprises a concentration meter 50. The concentration meter 50 allows the concentration of the target fluid to be determined based on samples taken from the fluid separation system 16. The concentration meter 50 can sample fluid from downstream of the first outlet 38 and upstream of the second vessel 42 via a first line 52. The first line 52 comprises a first isolation valve 54. The concentration meter 50 can sample fluid from downstream of the second outlet 40 of the separation device and upstream of the pressure control device 48 via a second line 56. The second line 56 comprises a second isolation valve 58. The first and second isolation valves 54, 58 allow the fluid sample to be taken from one point of the fluid separation system 16 such that the target fluid concentration at that particular point can be determined. From the concentration meter 50, the fluid sampled is vented to the atmosphere. In some non-depicted embodiments, the fluid separation system 16 may comprise further lines that branch off from any point in the fluid separation system 16. This allows the concentration of the target fluid at any point in the fluid separation system 16 to be determined.

The fluid separation system 16 further comprises a controller 60. The controller 60 controls the operation of the components of the fluid separation system 16. In particular, the controller controls operation of the first compressor 24, the second compressor 44, the flow control device 32 of the return line 26, and pressure control device 48, and the first and second isolation valves 54, 58. The controller 60 also receives information from the flow meter, the first vessel 22, the second vessel 42, and the third vessel 46.

The method of separating the target fluid from the fluid mixture will now be discussed with reference to FIG. 2. First, the inlet 18 of the fluid separation system 16 receives the fluid mixture. The inlet 18 of the fluid separation system 16 receives the fluid mixture from the leak test apparatus 2. The fluid mixture is then passed to the filter 20. In the filter 20, contaminants such as oil and/or moisture and/or dust are removed from the fluid mixture. Since the filter 20 is disposed upstream of the separation device 30, the fluid mixture is filtered prior to separating the target fluid from the first portion 34 of the fluid mixture. The fluid mixture is then provided to the first vessel 22. The first compressor 24 remains deactivated until the amount of fluid mixture in the first vessel 22 reaches the first threshold value, as discussed above. Once the first threshold value has been reached, the first compressor 22 is activated. Activating the first compressor compresses the fluid mixture. The first compressor 24 remains active until the second threshold value is reached. Once the second threshold value has been reaches, the first compressor 24 is deactivated, as discussed above.

The fluid mixture continues to the inlet 28 of the return line 26. Here, the fluid mixture is divided into the first portion 34 and a second portion 36. The second portion 36 is returned to upstream of the first compressor 24. The second portion 36 is returned to downstream of the first vessel 22. The first portion 34 of the fluid mixture is provided to the separation device 30. Since the return line 26 comprises a flow control device 32, the first portion 34 of the fluid mixture is provided to the separation deice 30 at the predetermined flow rate. That is to say, the flow control device 32 controls the flow rate of the first portion 34 of the fluid mixture. This may be done with reference to the flow rate of the first portion 34 as measured by the flow meter 32. The flow rate of the first portion 34 may be maintained at the predetermined flow rate. In the separation device 30, the target fluid is separated from the first portion 34 of the fluid mixture. Concurrently, the pressure control device 48 regulates the pressure of the first portion. In particular, the pressure control device 48 maintains the pressure of the first portion 34 that is disposed in the separation device 30 at the predetermined pressure value.

Next, the separated target fluid exits the separation device 30 via the first outlet 38. The separated target fluid is then provided to the second vessel 42. The second compressor 44 is activated once the amount of target fluid in the second vessel 42 reaches the first threshold value. Activating the second compressor 44 compresses the target fluid. The second compressor 44 remains active until the amount of target fluid in the second vessel 42 reaches the second threshold value. The target fluid, which at this stage may be referred to as the compressed target fluid, is then provided to the third vessel 46. The third vessel 46 may be referred to as a reservoir. The leak testing apparatus 2 is disposed downstream of the third vessel 46. The target fluid remains in the third vessel 46 until it is required for use by the leak testing apparatus 2. When the target fluid is required by the leak testing apparatus 2, the leak testing apparatus 2 draws in the target fluid. The target fluid then passes from the third vessel 46 to the leak testing apparatus 2 via the non-return valve.

The remainder of the first portion 34 of the fluid mixture, that is the portion of the first portion 34 that does not include the target fluid, exits the separation device 30 via the second outlet 40. The remainder of the first portion 34 of the fluid mixture is then vented to the atmosphere via the pressure control device 48. The pressure control device 48 regulates the pressure of the first portion 34 that is disposed in the separation device 30. In particular, the pressure control device 48 maintains the pressure of the first portion 34 of the fluid mixture that is disposed within the separation device 30 at a predetermined pressure value.

The method also comprises determining the concentration of the target fluid. The concentration of the target fluid may be determined at any stage of the method. The first and second isolation valves 54, 58 are usually in the closed position. To determine the concentration of the target fluid downstream of the separation device 30 and upstream of the second vessel 42, the first isolation valve 54 is opened. This allows the concentration meter 50 to measure the concentration of the target fluid that is exiting the first outlet 38 of the separation device. To determine the concentration of the target fluid downstream of the separation device 30 and upstream of the pressure control device 48 the second isolation valve 58 is opened. This allows the concentration meter 50 to determine the concentration of the target fluid downstream of the separation device 30 and upstream of the pressure control device 48. As discussed above, the fluid separation system 16 may comprise lines that lead to the concentration meter 50 that branch off from any point in the fluid separation system 16. This allows the concentration of the target fluid at any point in the fluid separation system 16 to be determined.

While specific embodiments of the invention have been described above, it will be appreciated that the invention may be practiced otherwise than as described. The descriptions above are intended to be illustrative, not limiting. Thus, it will be apparent to one skilled in the art that modifications may be made to the invention as described without departing from the scope of the claims set out below.

We claim:

1. A method of separating a target fluid from a fluid mixture, the method comprising:
receiving the fluid mixture from an apparatus;
compressing the fluid mixture using a first compressor;
dividing the fluid mixture into a first portion and a second portion;
returning the second portion to upstream of the first compressor;
providing the first portion to a separation device at a predetermined flow rate; and
separating the target fluid from the first portion of the fluid mixture with the separation device.

2. The method of claim 1, further comprising regulating, with a pressure control device that is disposed downstream of the separation device, the pressure of the first portion of the fluid mixture that is disposed in the fluid separation device.

3. The method of claim 2, wherein regulating the pressure in the fluid separation device comprises maintaining the pressure of the first portion of the fluid mixture that is disposed in the fluid separation device at a predetermined pressure value.

4. The method of claim 1, wherein returning the second portion to upstream of the compressor comprises returning the second portion to upstream of the compressor via a return line.

5. The method of claim 4, wherein the flow rate of the first portion is controlled using a flow control device that is disposed on the return line.

6. The method of claim 5, wherein the flow control device is disposed downstream of an inlet of the return line.

7. The method of claim 1, further comprising:
providing the separated target fluid to a first vessel;
compressing the target fluid with a second compressor; and
providing the compressed target fluid to a second vessel.

8. The method of claim 1, further comprising, prior to separating the target fluid from the first portion of the fluid mixture, filtering the fluid mixture.

9. (canceled)

10. The method of claim 1, wherein the separation device is a gas separation module.

11. The method of claim 1, wherein the separation device is a membrane filter.

12. The method of claim 1, wherein the apparatus is a leak testing apparatus.

13. (canceled)

14. A fluid separation system for recovering a target fluid from a fluid mixture, the fluid recovery system comprising:
an inlet that is configured to receive the fluid mixture;
a first compressor for compressing the fluid mixture;
a return line that comprises a return line inlet that is disposed downstream of the first compressor, such that, in use, the fluid mixture is divided into a first portion and a second portion; and
a separation device that is disposed downstream of the return line inlet;
wherein the return line is configured to return the second portion to upstream of the first compressor; and
wherein, in use, the first portion is provided to the separation device at a predetermined flow rate.

15. The fluid separation system of claim 14, wherein the return line comprises a flow control device.

16. The fluid separation system of claim 15, wherein the flow control device is disposed downstream of an inlet of the return line.

17. The fluid separation system of claim 16, further comprising a pressure control device that is disposed downstream of the separation device.

18. The fluid separation system of claim 17, wherein the pressure control device is configured in use to regulate the pressure of the first portion of the fluid mixture that is disposed in the separation device.

19. The fluid separation system of claim 17, wherein, in use, the pressure control device is configured to maintain the pressure of the first portion of the fluid mixture that is disposed in the separation device at a predetermined pressure value.

20. (canceled)

21. (canceled)

22. An apparatus comprising:
a fluid separation system for recovering a target fluid from a fluid mixture, the fluid recovery system comprising:
an inlet that is configured to receive the fluid mixture;
a first compressor for compressing the fluid mixture;
a return line that comprises a return line inlet that is disposed downstream of the first compressor, such that, in use, the fluid mixture is divided into a first portion and a second portion; and
a separation device that is disposed downstream of the return line inlet;
wherein the return line is configured to return the second portion to upstream of the first compressor;
wherein, in use, the first portion is provided to the separation device at a predetermined flow rate; and
a leak testing apparatus, an outlet of the leak testing apparatus being in fluid communication with the inlet of the fluid recovery system.

23. The apparatus of claim 22, wherein the leak testing apparatus is a helium leak testing apparatus.

24. The apparatus of claim 22, further comprising one or more further leak testing apparatus, an outlet of each of the one or more further leak testing apparatus being in fluid communication with the inlet of the fluid recovery system.
